(19) United States
(12) Patent Application Publication
(10) Pub. No.: US 2006/0002845 A1
(43) Pub. Date: Jan. 5, 2006

(54) Sulfuric acid process

(76) Inventors: Edward J. Lahoda, Pittsburgh, PA (US); Jason P. Mazzoccoli, Pittsburgh, PA (US)

Correspondence Address: Joseph C. Spadacene;Westinghouse Electric Company LLC, 4350 Northern Pike, Monroeville, PA, 15146, US

(21) Appl. No.: 11/054,235

(22) Filed: Feb. 9, 2005

Related U.S. Application Data
(60) Provisional application No. 60/584,100, filed on Jun. 30, 2004.

(51) Int. Cl. C01B 17/69

(52) U.S. Cl. 423/522

(57) ABSTRACT

A method of operating the standard Westinghouse Sulfur Process (2) or the standard Iodine Sulfur Process (4) both having the common initial reaction of H₂SO₄⇄SO₂+H₂O+O.5O₂, where over 760° C. of heat is required for the decomposition, and where the final reaction provides H₂ (6), where all the reactions proceed at an elevated pressure greater than 1100 psi (7.88 MPa) to allow recovery of SO₂ from H₂SO₄ decomposition at temperatures above 4.4° C.

### REFERENCE TO RELATED APPLICATIONS

This application claims priority of U.S. Provisional Patent Application No. 60/584,100 filed Jun. 30, 2004 under 35 U.S.C. §119.

### FIELD OF THE INVENTION

This invention describes improvements that can be incorporated into sulfuric acid based processes that use high temperature heat for all or a portion of the energy needs for a hydrogen production facility. These improvements include the use of a directly heated sulfuric acid decomposition reactor or the use of very high pressures in this reactor to reduce the need for cooling the process stream in order to capture most of the SO₂. These improvements dramatically increase the process energy efficiency of the sulfuric acid processes, avoid many of the materials engineering issues, and reduce the capital costs associated with the design and construction of the processes.

### BACKGROUND OF THE INVENTION

Sulfur cycles are a group of thermochemical processes that can make hydrogen, mainly using high temperature thermal energy from a high temperature heat source. Two sulfur cycles are the so called “Westinghouse Sulfur Process” and the “General Atomic Iodine/Sulfur Process”. The Westinghouse Sulfur Process (“WSP”), is described in Proceedings of ICONE 12, “Optimization of the Westinghouse Sulfur Process for Hydrogen Generation and Interface with an HTGR” by E. J. Lahoda et al. 12^{th} Intl. Conference on Nuclear Engineering, Arlington, Va., dated Apr. 25-29, 2004, pp 1-3; and in AICHE Reports “Interfacing the Westinghouse Sulfur Cycle with the PBMR for the Production of Hydrogen” by R. Matzie et al., New Orleans, dated Feb. 27, 2004 pp 1-10. The Iodine/Sulfur (“S/I”) Process is described in Proceedings of ICONE-11, “Nuclear Energy in Non-Electric Power Applications” by E. J. Lahoda et al., 11^{th} International Conference on Nuclear Engineering, Tokyo, Japan, Apr. 20-23, 2003, pp 1-9. Both processes are compared in American Nuclear Society Global Paper #88017, “Improvements in the Westinghouse Process for Hydrogen Production” by J. E. Goossen et al., American Nuclear Society Annual Winter Meeting, New Orleans, La. Nov. 2003, pp 1-5. At 1000° C. only the WSP system reaches 50% efficiency. Both cycles require temperatures in excess of 760° C. to have at least 40% efficiency.

The high temperature heat sources are any that produce heat available for use above 760° C., such as an HTGR (High Temperature Gas Cooled Reactor), a high temperature solar concentrator, a natural gas fired combustor or any combination of these heat sources. The portion of the process where sulfuric acid is decomposed into sulfur dioxide (SO₂), water vapor and oxygen typically takes place at these high temperatures. The first issue with these cycles is to have an efficient method for capturing the SO₂. This is due to the relatively low solubility of the SO₂ in water. The Westinghouse Sulfur Process (“WSP”) generates hydrogen using high temperature process heat and electricity. The energy to drive the WSP as well as other sulfur cycle based processes such as the Sulfur-Iodine process is pulled from the power generation loop of a HTGR such as a Pebble Bed Modular Reactor (“PBMR”).

The Westinghouse Sulfur Process produces hydrogen in a low-temperature electrochemical step, in which sulfuric acid and hydrogen are produced from sulfurous acid. This reaction can be run at between 0.17 and 0.6 volts with a current density of 200 ma/sq.cm at about 60° C. The second step in the cycle is the high temperature decomposition of sulfuric acid at 760° C. or above. Previous work by Westinghouse has identified catalysts and process designs to carry out this reaction in concert with an HTGR such as the PBMR. The final step in this process is absorption of the SO₂ in water at room temperature to form sulfurous acid and a SO₂ free stream of O₂.

This is a well known process which is hereby defined as “standard WSP”=

(1) H₂SO₄⇄SO₂+H₂O+O.5O₂ (>760° C. heat required)];

(2) SO₂+2H₂O+0.50₂⇄H₂SO₃+H₂O+O.5O₂ (T<100° C.); and

(3) H₂O+H₂SO₃→H₂+H₂SO₄ (electrolyzer at about 100° C. or less).

The Iodine/Sulfur Process also starts with a reversible reaction where sulfuric acid is decomposed at over 760° C. to form sulfur dioxide as above, followed by reaction of the sulfur dioxide with Iodine to form HI.

This is a well known process which is hereby defined as “standard S/I”=

(1) H₂SO₄⇄SO₂+H₂O+O.5O₂ (greater than 760° C. heat required)

(2) I₂+SO₂+2H₂O+O.5O₂+excess H₂O⇄2HI+H₂SO₄+O.5O₂+excess H₂O (about 100° C. to 200° C. heat generated); and

(3) 2HI⇄H₂+I₂ (greater than 400° C. heat required)

The common step is:
H₂SO₄⇄SO₂+H₂O+O.5O₂

What is needed is an improvement to the WSP and S/I systems to improve efficiency and solve materials corrosion issues as well as reduce capital costs. It is a main object of this invention to provide such an efficient, corrosion reduced, cost effective system.

### SUMMARY OF THE INVENTION

The above needs are met and issues solved by providing a method of operating the standard Westinghouse Sulfur Process (standard WSP) or the standard Iodine Sulfur Process (standard S/I) at a pressure greater than 1100 psi (7.58 MPa) to allow recovery of SO₂ from a H₂SO₄ decomposition step at temperatures above 4.4° C. with lower H₂O to SO₂ ratios. Preferably the pressure will be greater than 1200 psi (8.27 MPa) and most efficiently greater than 1450 psi (10.0 MPa) up to 1700 psi (11.7 MPa). Preferably the SO₂ will be recoverable at from 20° C. to 75° C. The use of the above pressures will allow the SO₂ absorption reaction: SO₂+H₂O⇄H₂SO₃ (>120° C.) for both standard WSC and standard S/I systems to run without refrigeration. This also allows both systems as noted above to reduce the number of moles H₂O required in the reactions by up to 50%, preferably by 15% to 50%:
WSP: H₂O+SO₂ →H₂SO₃
SI: I₂+SO₂+H₂O⇄2HI+SO₃

In these methods, a plurality of direct contact reactors can be used for the decomposition of sulfuric acid or SO₃, where the use of a plurality of direct contact reactors allows the use of ceramic materials as heat transfer media and/or catalyst supports in the reactors. Also, a plurality of direct contact reactors can be operated in alternating sequence in conjunction with a nuclear reactor using He as a coolant, and He or a molten salt can be used as a heat transfer medium between a high temperature heat source such as a high temperature reactor and a decomposition reactor.

In these methods, zeolite or other absorbent beds can be used to remove sulfur compounds, radioactive materials or other transfer compounds or decomposition products from intermediate heat transfer loops or from the gas stream, back to the high temperature heat source. These zeolite or other absorbent beds provide a thermal capacitance and a means of leveling out temperature variation due to process upsets in either the high or low temperature processes.

### BRIEF DESCRIPTION OF THE DRAWINGS

A full understanding of the invention can be appreciated from the following detailed description of the invention when read with reference to the accompanying drawings wherein:

FIG. 1 is a schematic diagram of one embodiment of the so called Westinghouse Sulfur Process Cycle (“WSP”);

FIG. 2 is a schematic diagram of the Sakuri embodiment of the so called Iodine/Sulfur Process (“S/I”);

FIG. 3 is a graph of the change in efficiency vs. wt % sulfuric acid in a WSP system operating at 1,450 psi vs. 1,000 psi;

FIG. 4, which best describes the invention, is a block diagram of a directly heated reactor system; and

FIG. 5 is a diagram of an indirectly heated reactor.

### DESCRIPTION OF THE PREFERRED EMBODIMENT

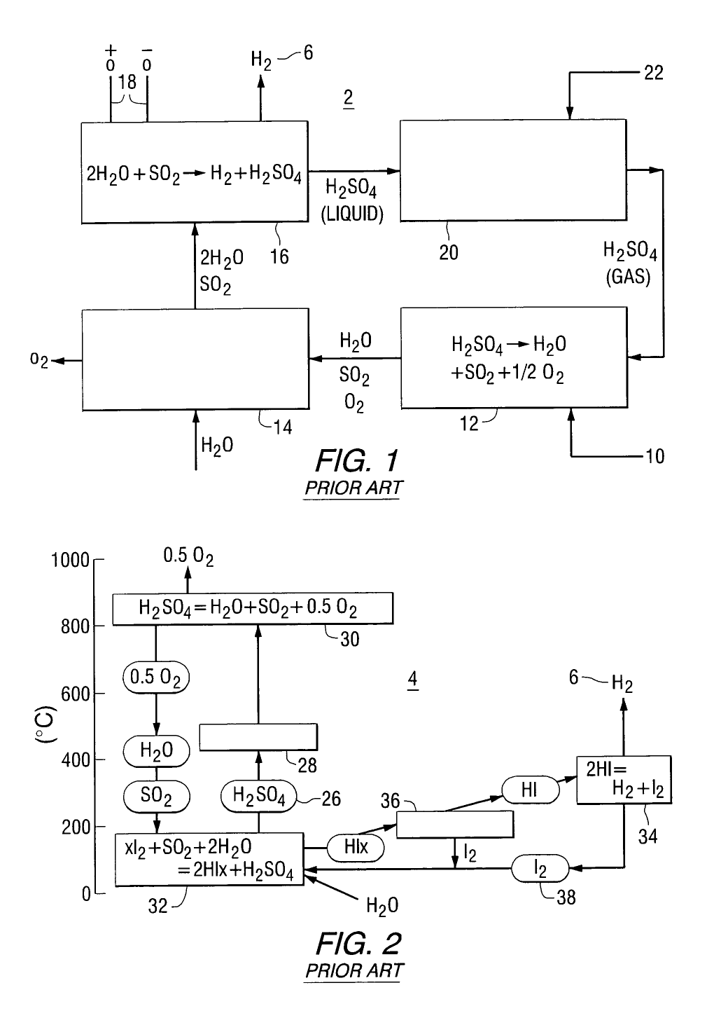

Referring to FIG. 1, a standard WSP process 2 is shown operating at less than 900 psi. In FIG. 2, the standard S/I process 4 is shown operating at less than 900 psi. In FIG. 1, thermal energy 10 at about 760° C. to 1000° C. is passed into oxygen generator 12 to provide the reaction shown, passing H₂O, SO₂ and O₂ to an oxygen recovery unit 14 where H₂O and SO₂ are passed to an electrolyzer 16 energized with D.C. electricity 18 to provide H₂ shown as 6 and H₂SO₄, where the latter is vaporized in vaporizer 20 by thermal energy 22 to feed vaporized H₂SO₄ to the oxygen generator/sulfuric acid decomposition reactor 12, as shown.

As shown in FIG. 2, a Sakuri 2000 process schematic of the reactions for S/I vs. temperature, sulfuric acid 26 is vaporized in vaporizer 28 and then passed to decomposition reactor 30 at about 760° C. to 810° C. to generate O₂ and pass O₂, H₂O and SO₂ to iodine reactor 32 which generates HI which is decomposed in second decomposition reactor 34 to provide H₂ shown as 6 after passing through the excess I₂ separator 36. The decomposition reactor 34 provides the main source of I₂, shown as 38 for the iodine reactor 32, also known as a Bunsen reactor.

By operating the entire WSP or SI cycle at a high pressure of roughly 1450 psi (10.0 MPa-mega pascals), we have found that SO₂ can be removed from the system at temperatures above 20° C., preferably at 20° C. to 75° C., without the use of energetically inefficient refrigeration systems or excess water. In addition, operation of the cycle at a higher pressure would allow for the removal of SO₂ in one consolidated step, due to higher removal efficiency of the SO₂ by water. High system pressure operation has other advantages. The use of high pressure can also increase overall process efficiency by allowing for the direct gas phase conversion of sulfurous acid (H₂SO₃) to sulfur trioxide and hydrogen in the electrolyzer, the hydrogen generation portion of the Westinghouse Sulfur Process (“WSP”). Consequently, for every mole of H₂ produced, only one mole of H₂O and one mole of SO₂ is required.

The hydrogen generation reaction under this scheme is: H₂O+SO₂→H₂SO₃→H₂+SO₃. If a lower pressure is used (<1000 psi), more water must be used to separate out the SO₂ from the O₂. This results in a lower concentration of sulfurous acid (H₂SO₃). During the vaporization step, additional energy must be used to vaporize the excess water. The hydrogen generation reaction at lower pressures is: 2H₂O+SO₂→H₂+H₂SO₄.

Thus the steps of WSP previously defined in the background are changed to:

(1′) SO₃⇄SO₂+O.5O₂ (greater than 1100 psi and >760° C. heat required)

(2′) H₂O+SO₂+O.5O₂⇄H₂SO₃+O.5O₂

(3′) H₂SO₃⇄H₂+SO₃

(electrolyzer at 100° C. and 1450 psi).

In the S/I process, the overall reactions are not changed, but the resulting sulfuric acid (26 in FIG. 2) is a higher concentration and as in the case of the WSP, the energy required for vaporization is reduced, providing:

(1′) SO₃⇄SO₂+O.5O₂

(2′) I₂+SO₂+H₂O⇄2HI+SO₃

(3′) 2HI⇄H₂+I₂

In effect, operating the entire system at high pressure allows sulfurous acid to be converted in the electrolyzer to hydrogen and sulfur trioxide, which in turn increases overall efficiency by reducing the water requirement of the entire cycle up to 50%, leading to reduced energy requirements for the vaporizers of both the WSP and S/I processes. An added benefit of high system pressure is a compressed hydrogen product and a compressed oxygen product that do not require further compression.

In order to test the increase in the efficiency of these processes, chemical process models of the WSP were executed at a variety of pressures. At a pressure of 1,000 psi (6.9 MPa), the required temperature to dissolve sulfur dioxide into the water feed stream while achieving a low residual SO₂ level in the O₂ product was found to be roughly 40° F. (4.4° C.). Cooling the water inlet stream and the oxygen generation products (H₂O, SO₂ and O₂) to 40° F. (4.4° C.) requires the use of inefficient refrigeration equipment. For this analysis, it was assumed that the cooling efficiency of the refrigeration equipment was 50%. An electrical to thermal energy conversion rate of 42% was used to convert electrical energy into reactor thermal energy. These conversion percentages mean that for every unit of electrical energy used in the cooling of these streams, the thermal equivalent is roughly five times higher. It was found that by operating the system at 1,450 psi (10.0 MPa), the SO₂ dissolved in water at a temperature of 70° F. (21.1° C.), requiring 30° F. less cooling. The result is that the thermal efficiency of the WSP is increased by 15-20%.

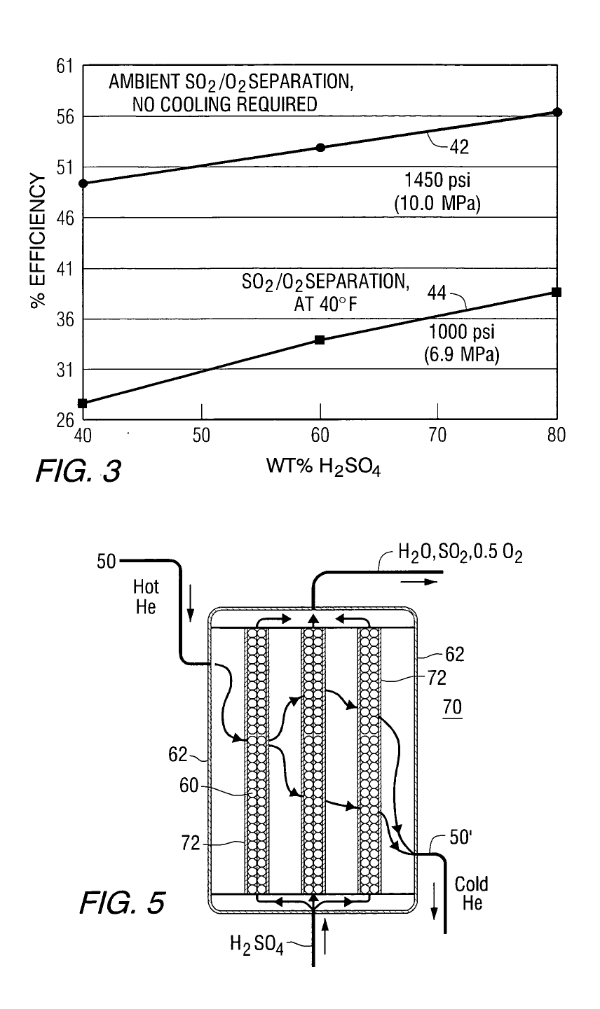

The overall thermal efficiency (calculated using the lower heating value of H₂) of the WSP as a function of sulfuric acid weight percentage is shown in FIG. 3. The use of higher pressures results in dramatic improvement in efficiency, line 42 vs. low pressure results, line 44. In addition to higher process efficiencies, higher operation pressures are desirable to avoid the need for compression of the hydrogen product which incurs a large energy penalty on the system. There is also an added benefit of minimizing process equipment size and capital cost. As modeled, the removal of sulfur dioxide from the oxygen can be accomplished in a single unit operation. Similar results would occur for the SI system.

Another major issue regarding these cycles is the materials of construction and the operation of the high temperature decomposition reactor, in which the reaction of the H₂SO₄⇄SO₂+H₂O+O.5O₂ takes place. Corrosion is an issue due to the high temperature (>760° C.) and the chemically aggressive character of the components (H₂SO₄, SO₂, SO₃, H₂O and O₂). Since this vessel will operate at high temperature and pressure, a process approach that would utilize relatively low cost materials construction while still being corrosion resistant and have good heat transfer capabilities with low maintenance requirements is required for the economic feasibility of this family of processes.

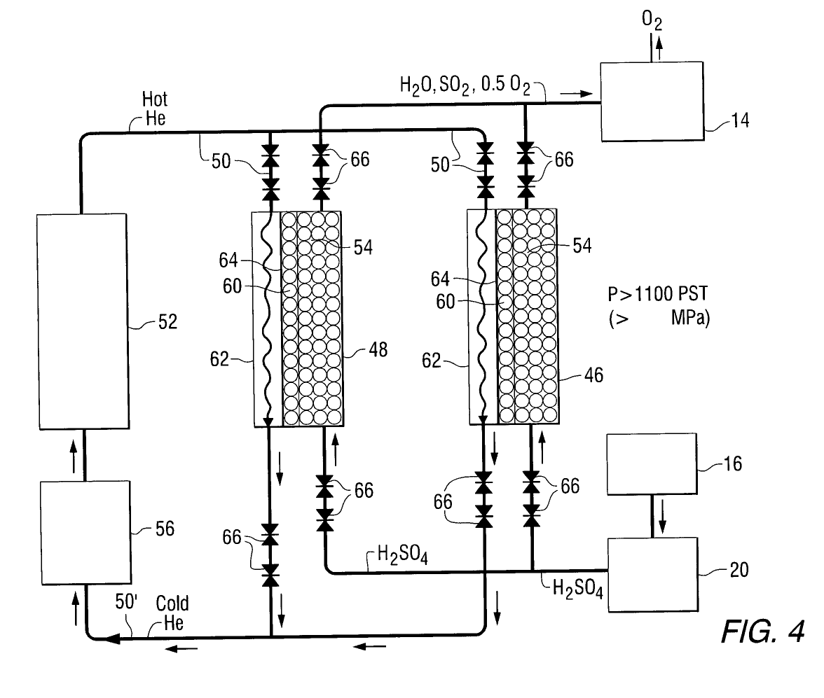

In order to solve the sulfuric acid decomposition reactor issues, the use of a plurality of directly heated, direct contact sulfuric acid decomposition reactors 46, 48 as shown in FIG. 4 is proposed. In this approach, a hot heat transfer medium 50 (for instance helium) from a nuclear reactor 52, or intermediate heat exchanger that is heated by a reactor or other energy source is sent through one reactor to heat a bed 54 of alumina or zirconia or other types of material suitable to this environment. The bed has a catalytic surface that increases the rate of sulfuric acid decomposition reaction. Sulfuric acid is received from electrolyzer 16 and vaporizer 20. Once the bed in the first reactor 46 has reached the appropriate temperature (for instance 760° C. to 925° C.), the hot heat transfer fluid 50 is diverted to the second, now cold, reactor 48 to begin heating it. In the meantime, sulfuric acid vapor is then sent through the first (now hot) reactor 46 where the decomposition reaction takes place and gradually cools the reactor due to the endothermicity of the decomposition process.

Once the first reactor 46 has cooled to below a minimum operating temperature and the second reactor 48 has reached the desired temperature, hot heat transfer 50 fluid is diverted back to the first reactor 46 that has now cooled. The sulfuric acid flow is then diverted from the first reactor 46 to the second, now hot, reactor 48. Of course, more than two reactors can be used so as to optimize the cycle time. In addition, the cycling can be timed such that some initial heat transfer medium flow is first put through the cold reactor and then through a zeolite bed to remove any residual sulfuric acid vapor before the full heat transfer medium flow is re-initiated.

A circulator 56 is also shown as well as oxygen recovery unit 14 and various valves 66. The application of such technology is also applicable to the other “sulfur family” of hydrogen generating thermochemical cycles like the S/I system. Variations of their features and attached processes may occur depending on specific design requirements and adjacent processes.

The use of a plurality of directly heated reactors allows a much closer approach of the reactor bed to the temperature of the hot heat transfer medium. This higher temperature in turn increases the conversion of the sulfuric acid vapors. These higher conversion rates reduce the total flow rate in the process and the attendant parasitic loses for cooling, reheating and pumping. Other benefits of using the directly heated reactor approach of FIG. 4 are the ability to use much lower grade materials.

While both the intermediate heat exchanger (shown in FIG. 5) and the directly heated reactor designs (shown in FIG. 4) can use low cost carbon steel or stainless steel outer vessels 62, lined with ceramics or other suitable materials; the tubes 72 that contain the catalyst 60 and are the heat transfer surfaces in the indirect heat exchanger design, will have to be of very expensive alloy (if one can be identified) in order to withstand the temperature and pressure while providing corrosion resistance.

The directly heated reactor shown in FIG. 4 can use non-structural catalyst support material 60 such as alumina, zirconia, or other appropriate materials with or without a catalytic surface as the heat transfer media. Suitable seals 64 that maintain the boundary between the sulfuric acid vapor and the hot helium must also be identified for intermediate heat exchangers.

A final consideration is the efficient transfer of heat across the tubes 72 and into the catalyst bed on the inside of the tubes for the intermediate heat exchanger 70. Since the decomposition reaction is very endothermic, this may be a significant design issue that may require the use of extremely high surface area to volume ratios for the heat transfer area. Again, this will increase both the capital cost and the likelihood that significant maintenance costs will be required during operation for intermediate heat exchangers 70, an example of which is shown in FIG. 5. The complete separation of the heat transfer medium and sulfur process streams may also reduce regulatory issues due to leakage of sulfuric acid into the reactor or intermediate heat exchanger circuit if an HTGR is used as a heat source.

The large thermal mass of the reactor beds in the direct contact reactors of FIG. 4 will minimize the effect of process upsets. This concept will add operating stability to the system to allow either the heat source or the hydrogen process to coast through an instability caused by the other process. Elimination of material expansion/contraction issues in the tubesheet/tube interface of the intermediate heat exchanger of FIG. 5 and eliminate the attendant sealing issues. Finally, a lower pressure drop due to the ability to use larger catalytic materials for the bed 54 of the reactor(s) 46, 48 of the directly heated reactors will result.

Obstacles do exist in the use of the directly heated reactors preferred in this invention and shown in FIG. 4. As mentioned above, the use of an auxiliary process to maintain a clean heat transfer medium will likely be required to eliminate the potential for corrosion issues in the intermediate heat exchanger or reactor and to eliminate the production of activated species of sulfur.

Some direct advantages of the above highly pressurized, directly heated reactor system of this invention (FIG. 4) include:
The use of higher system pressure allows for the consolidation of the SO₂ recovery process to a single unit operation.
The use of higher system pressures allows for gas phase conversion of sulfurous acid (H₂SO₃) to SO₃ and H₂ in the electrolyzer, thereby reducing the power needs of the electrolyzer by minimizing the use of water.
The use of higher pressure system allows for increased efficiency due to the high temperature decomposition of SO₃ rather than more complex H₂SO₄. Again, this is due to the reduced water requirement of the system.
A plurality of direct contact reactors for sulfuric acid and SO₃ decomposition can be used in hydrogen generating sulfur cycles such as the Westinghouse Sulfur Process and the Sulfur Iodine Process; two or more reactors in alternating sequence as direct contact reactors can be used.
Ceramic materials as the heat transfer media and or catalyst support can be used in the direct contact reactors instead of expensive materials for the heat transfer surfaces.
Inexpensive ceramic may be used instead of expensive, pressure bearing ceramic and or metal as the boundary between the hot and cold portions of the decomposition reactor.
No seals that are difficult to fabricate and maintain are needed between the cold and hot portion of the decomposition reactor.
No seals are required between the hot, clean gas from the reactor and the decomposing SO₃ and H₂SO₄.
Thermal capacitance is supplied to minimize the effects of process variations either in the chemical or nuclear processes.

Inexpensive auxiliary processes to clean up residual contamination in the heat transfer medium can be used to mitigate any SO₂; SO₃ or S species carryover to the clean hot gas system. The advantages of this approach include:
A thermal capacitance is further added to the clean gas stream to help level out variations in the cold chemical or hot gas supply processes.
Besides trapping sulfur based compounds, these beds will insure minimal radioactive contamination of the chemical process stream, during equipment failure or accidental in the nuclear heat generation process

Having described the presently preferred embodiments, it is to be understood that the invention may be otherwise embodied within the scope of the appended claims.

What is claimed is:

1. A method of operating the standard Westinghouse Sulfur Process or the standard Iodine Sulfur Process by increasing the pressure to greater than 1100 psi to allow recovery of SO₂ at temperatures above 4.4° C., with lower H₂O to SO₂ ratios.

2. The method of claim 1, wherein the pressure will be greater than 1200 psi.

3. The method of claim 1, wherein the pressure will be from 1450 psi to 1700 psi.

4. The method of claim 1, wherein recovery of SO₂ from H₂SO₄ will be at temperatures from 25° C. to 75° C.

5. The method of claim 1, where, with the pressure operating at greater than 1100 psi, the standard Westinghouse Sulfur Process reactions:
(1) H₂SO₄⇄SO₂+H₂O+O.5O₂;
(2) SO₂+2H₂O+0.50₂⇄H₂SO₃+H₂O+0.50₂; and
(3) H₂O+H₂SO₃→H₂+H₂SO₄, will be changed to
(1′) SO₃⇄SO₂+O.5O₂
(2′) H₂O+SO₂+O.5O₂⇄H₂SO₃+O.5O₂ and
(3′) H₂SO₃→H₂+SO₃

6. The method of claim 1, where, with the pressure operating at greater than 1100 psi, the standard Iodine Sulfur Process reactions:
(1) H₂SO₄⇄SO₂+H₂O+O.5O₂ (greater than 760° C. heat required)
(2) I₂+SO₂+2H₂O+O.5O₂+excess H₂O⇄2HI+H₂SO₄+O.5O₂+excess H₂O (heat generated) and
(3) 2HI⇄H₂+I₂ (heat required), will be changed to:
(1′) SO₃⇄SO₂+O.5O₂ (greater than 1100 psi and greater than 800° C. heat required)
(2′) I₂+SO₂+H₂O→2HI+SO₃ and
(3′) 2HI⇄H₂+I₂

7. The method of claim 1, wherein the use of an operating pressure greater than 1100 psi, allows consolidation of SO₂ recovery into a single unit operation.

8. The method of claim 5, wherein the use of an operating pressure greater than 1100 psi, allows for gas phase conversion of sulfurous acid (H₂SO₃) to SO₃ and H₂ in an electrolyzer, reducing power needs of the electrolyzer by minimizing water evaporation requirement of the system.

9. The method of claim 5, wherein the use of an operating pressure greater than 1100 psi, allows for increased efficiency due to the high temperature decomposition of SO₃ rather than the more complex H₂SO₄, reducing the water requirement of the system.

10. The method of claim 5, wherein a plurality of direct contact reactors are used for the decomposition reactions.

11. The method of claim 10, wherein the use of a plurality of direct contact reactors, allows the use of ceramic materials as heat transfer media and/or catalyst supports in the plurality of direct contact reactors for decomposition of sulfuric acid and SO₃.

12. The method of claim 10, wherein a plurality of direct contact reactors are operated in alternating sequence, in conjunction with a nuclear reactor using He as a coolant, and He or a molten salt as a heat transfer medium between a high temperature heat source such as a high temperature reactor and a decomposition reactor.

13. The method of claim 12, wherein zeolite or other absorbent beds are used to remove sulfur compounds, radioactive materials or other transfer compounds or decomposition products from intermediate heat transfer loops or from a gas stream back to the high temperature heat source.

14. The method of claim 13, wherein the zeolite or other absorbent beds provide a thermal capacitance and a means of leveling out temperature variation due to process upsets.
